(19) United States
(12) Patent Application Publication
(10) Pub. No.: US 2008/0145025 A1
(43) Pub. Date: Jun. 19, 2008

(54) Method and System for Selecting Media Content

(75) Inventors: Michael R. Wimberly, Sammamish, WA (US); Richard D. Snelson, Redmond, WA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,000

(22) Filed: Dec. 13, 2006

(51) Int. Cl. H04N 7/00

(52) U.S. Cl. 386/95

(57) ABSTRACT

A method and a system for selectively providing media content from a database (206) of media files are provided. A plurality of media files is stored within the database (206). Each of the stored media files are identified by an overall primary content rating. A plurality of media segments are included in each of the media files. Each of the media segments are identified by a secondary content rating. A user interface (202) receives a user-generated message requesting access to at least one particular one of the stored media files. The desired content rating for the requested media file is also specified. The interface (204) retrieves the media segments of the requested particular media file that do not exceed the specified desired content rating. Furthermore, the interface (204) provides a user with access to the retrieved media segments.

### FIELD OF THE INVENTION

This invention relates in general to content selection through an entertainment player, and more particularly, to a method and a system for selecting media content through a media retrieval appliance.

### BACKGROUND OF THE INVENTION

Over the years, reduced prices of entertainment devices and media content have motivated people to watch the entertainment media from the comfort of their homes. Examples of the entertainment media include media contents such as movies, songs, videos, television programs, selected advertisements, video games and sporting events. The media content can be watched selectively through the entertainment devices, such as a movie on a DVD player, or through a direct satellite communication, for example a song on a direct to home service radio.

Since these entertainment devices have, over the years, become easy to operate, anyone can operate them without much or any guidance. This has lead to a growing realization that there exists a need to monitor the media content being watched by minors. For example, the parents need to monitor whether their children are exposed to any objectionable media content, such as a pornographic movie. Access to such objectionable media content needs to be restricted for the minors. There exists ways for imposing such restrictions. For example, there exists a child lock facility in display mediums to restrict access of few media transmissions. Such facilities can prohibit children from watching the restricted media transmissions.

However, existing restrictions, such as the child lock facility, restrict the reception of the corresponding media content. In such situations, the child will not be able to watch any non-objectionable media content of the restricted transmission channel. For example, if the parents restrict access of the child to a particular television channel because few media contents, transmitted on the television channel, are objectionable, the child will not be able to watch non-objectionable media content, such as a news telecast, a quiz contest, and so forth, on the restricted television channel.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary environment in which various embodiments of the present invention can be practiced;

FIG. 2 illustrates a block diagram of a media retrieval appliance, in accordance with an embodiment of the present invention;

FIG. 3 illustrates a flow diagram of a method for selectively providing media content from a database of media files, in accordance with an embodiment of the present invention; and

FIG. 4 illustrates a flow diagram of a method for selectively providing media content from the database of media files, in accordance with another embodiment of the present invention.

Skilled artisans will appreciate that elements in the figures have been illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for selecting media content, in accordance with various embodiments of the present invention, it should be observed that the present invention resides primarily in combinations of method steps and apparatus components related to the method and system for selecting media content. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, relational terms such as “plurality”, “primary” and “secondary”, and the like, may be used solely to distinguish one entity or action from another entity or action, without necessarily requiring or implying any actual relationship or order between such entities or actions. The terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a”, does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

For an embodiment, a method for selectively providing media content is described. The media content is selected from a database of media files. The method includes storing a plurality of media files. Each of the stored media files is identified by an overall primary content rating. Each of the media files includes a plurality of media segments, which are identified by secondary content ratings. The method also includes receiving a user-generated message requesting access to at least one particular one of the stored media files. The desired content rating for the requested media file is also specified in the user-generated message. Further, the method includes retrieving the media segments of the requested particular media file that do not exceed the specified desired content rating. Furthermore, the method includes providing the user with access to the retrieved media segments.

For another embodiment, a media retrieval appliance is described. The media retrieval appliance includes a user interface. The user interface is adapted to receive a user-generated request for access to at least a particular one of a plurality of stored media files. The user interface is also adapted to facilitate the specified content rating for the requested media file. The media retrieval appliance also includes an interface. The interface provides a connection with a database that stores a plurality of media files. Each of the stored media files are identified by an overall primary content rating. Each of the media files has a plurality of media segments that are identified by secondary content ratings. Further, the media retrieval appliance includes a transceiver. The transceiver is adapted to transmit the user-generated request to the database via the interface. The transceiver also receives the media segments of the requested particular media file that do not exceed the specified desired content rating in response to the transmitted request.

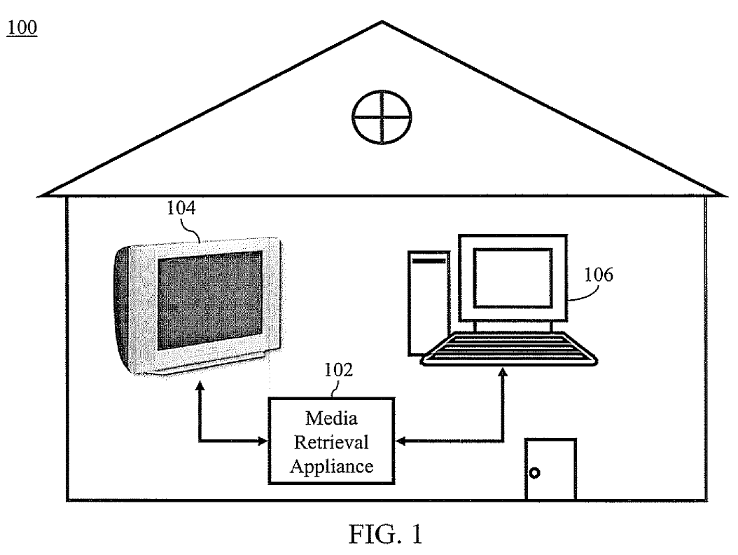

FIG. 1 illustrates an exemplary environment 100 in which various embodiments of the present invention can be practiced. With advanced technologies, surround home theatres and similar media players have evolved, which provide better alternative to watch entertainment media in a familiar and comfortable environment of home or an office. Examples of the entertainment media includes media contents like, but are not limited to, movies, songs, videos, television programs, advertisements, video games and sporting events. These media contents can be watched using entertainment devices, hereinafter referred to as a Media Retrieval Appliance (MRA) 102. Examples of the MRA 102 include, but are not limited to, a Compact Disk (CD) player, a Digital Versatile Disk (DVD) player, a mobile phone, an MPEG-1 Audio Layer 3 (mp3) player, set-top box and a music system. [Query for the inventors: Please let us know if there are any other types of MRA that you would like us to include, in addition to those listed above.] For example, the set-top box is a device connected to a display medium such as television and receives some external signals. These external signals are converted into content and are displayed via a display medium.

For enabling display or feature enhancement, the MRA 102 may be communicably coupled to other entertainment devices. For example, as shown in FIG. 1, the MRA 102 is shown to be connected to a television 104 and a computer 106. The television 104 and the computer 106 are the display mediums, through which a user is able to watch the media contents via the MRA 102. It will be obvious to people skilled in the art that though only two entertainment devices, the television 104 and the computer 106, are shown in FIG. 1 for the purpose of bringing clarity to the description, the present invention can also be implemented with other entertainment devices such as projectors, and the like MRAs.

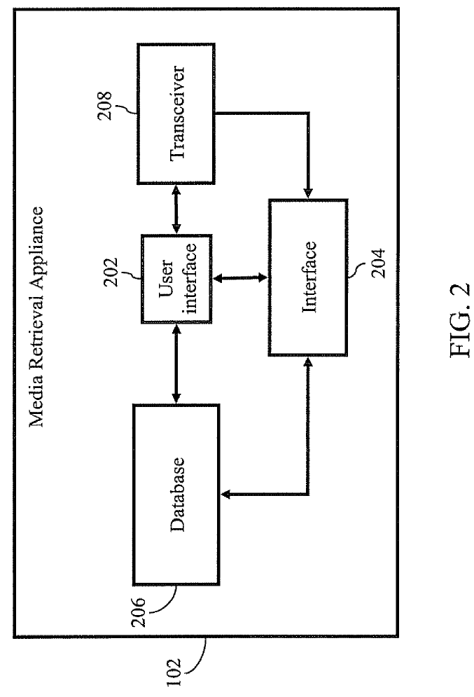

FIG. 2 illustrates a block diagram of the MRA 102, in accordance with an embodiment of the present invention. It will be obvious for a person ordinarily skilled in the art that the block diagram can be implemented with reference to many other suitable embodiments of the present invention. The MRA 102 includes a user interface 202, an interface 204, a database 206 and a transceiver 208. The user interface 202 is adapted to receive a user-generated request to access media file(s) stored in the MRA 102. The interface 204 provides a connection to the user interface 202 with the database 206.

The database 206 stores the media files. The media files include, but are not limited to, movies, songs, videos, television programs, advertisements, video games and sporting events. For an embodiment, the database 206 may be present on a network server (not shown in FIG. 2). In this embodiment, the database 206 can be accessed through a network, by any of the user connected to the network. Examples of the network include, but are not limited to, Personal Area Network (PAN), Local Area Network (LAN), Metropolitan Area Network (MAN) and Wide Area Network (WAN). [Query for the inventors: Please let us know if there are any other types networks that you would like us to include in addition to those listed above.] For another embodiment, the database 206 may be a customer premises storage system. Examples of the customer premises storage system include, but are not limited to, a Compact Disk (CD) player, a Digital Versatile Disk (DVD) player, a mobile phone, an MPEG-1 Audio Layer 3 (mp3) player, a computer and a music system. [Query for the inventors: Please let us know if there are any other types of customer premises storage systems that you would like us to include in addition to those listed above.] For yet another embodiment, the database 206 may comprise a computer-readable media. Examples of the computer-readable media include, but are not limited to, a hard disk, a CD-ROM, an optical storage device and a magnetic storage device. [Query for the inventors: Please let us know if there are any other types of computer-readable media that you would like us to include in addition to those listed above.]

Each one of the stored media files in the database 206 is identified by a content rating. Examples of the content rating for a media content watched on television display include, but are not limited to, a TV-Y (all children), a TV-Y7 (directed to children 7 and older), a TV-G (general audience), a TV-PG (parental guidance suggested), a TV-14 (parents strongly cautioned), and a TV-MA (mature audience only). Further examples of the content ratings of the media contents especially for movies include, but are not limited to, a general audiences (G) rating, a parental guidance suggested (PG) rating, a parents strongly cautioned (PG-13) rating, a restricted (R) rating and a NC-17 (no one under 17) rating. It will be obvious to a person skilled in the art that there can be different content ratings for different media files.

Each one of the stored media files in the database 206 is identified by an overall primary content rating. The primary content rating of a media file is decided based on the suitability of the media file for users of different age group. For example, a media file may contain some objectionable media contents and hence may be given the primary content rating of TV-14 or PG-13, thereby making the content unsuitable for children below the age of 14 to view. [Query for the inventors: Please let us know if there are any other criteria for deciding the primary content rating of the media files in addition to those listed above.] Each media file includes one or more media segments. Each of the media segments of the media files stored in the database 206 are identified by secondary content rating. The secondary content rating of the media segment is decided based on the suitability of the media segment for users of different age group. For example, if a user is watching a movie with primary rating of PG along with his family, he will be able to select a suitable secondary content rating from the menu of content rating. Few objectionable media segments of the movie can be restricted by choosing a suitable secondary content rating. [Query for the inventors: Please let us know if there are any other criteria for deciding the secondary content rating of the media files in addition to those listed above.]

For an embodiment, the multiple media files stored in the database 206 can include redundant media segments. The redundant media segments may be encoded in different ways, having dissimilar secondary content ratings. For example, few objectionable sections of the media file that are not supposed to be watched by children may be skipped, or blurred, or objectionable dialogues may be replaced with a beep sound. If a child aged 12 years access the MRA 102, he will not be able to access a PG-13 rated media segment. However, the PG-13 rated media segments may be stored in different media file with PG rating. While viewing the objectionable media segments of the PG rated media file might be skipped in PG-13 rated format of the media file.

A menu of content ratings may be provided to the user by the user interface 202. The user may be asked for an identification, may be in the form of an identification message, before specifying the primary and secondary content rating for the requested media file. Examples of the identification message include, but are not limited to, a password, a finger print recognition, a retinal scan and a RF key fob. [Query for the inventors: Please let us know if there are any other types of identification messages that you would like us to include in addition to those above listed.] If the identification message provided by the user matches with a predefined criteria, for example stored profiles on the database 206, then the user is granted access to the media content rating option. The predefined criteria may be an identification message provided by the user to the MRA 102 initially for his identification every time the user accesses the MRA 102, or the stored profiles. The predefined criteria are stored in the database 206 for reference. The primary and secondary content rating provided to the user for selection are based on the identification of the user. For example, if a child aged 13 years is accessing the MRA 102, then he will be given limited media content rating options to select from, such as TV-Y or G. The 13 year old child will not be able to access NC-17 rating options. The user can specify desired primary and secondary content ratings for the requested media file via the user interface 202.

For an embodiment, the user interface 202 communicates the user-generated request to the transceiver 208. The transceiver 208 transmits the user-generated request to the database 206 via the interface 204. For example, when the database 206 is present on a network, then the transceiver 208 is required to enable communication between the user interface 202 and the database 206. The interface 204 retrieves the media segments of the requested particular media file from the database 206. The transceiver 208 receives the media segments of the requested particular media file from the interface 204. The media segments received by the transceiver 208 do not exceed the desired content ratings specified by the user. For example, if a child aged 13 years is accessing the MRA 102, the transceiver 208 will receive the media segments of TV-Y rating, TV-Y7 rating, TV-G rating or G-rating. Media segments of NC-17 rating or TV-14 rating will not be made available to the child. For another embodiment, the user interface 202, the interface 204, and the database 206 are present in the MRA 102. As per this embodiment, a transceiver is not required for the internal communication of the user interface 202 and the database 206. [Comment for the inventors: Please confirm our understanding of the two embodiments for the transceiver described in the above paragraph.]

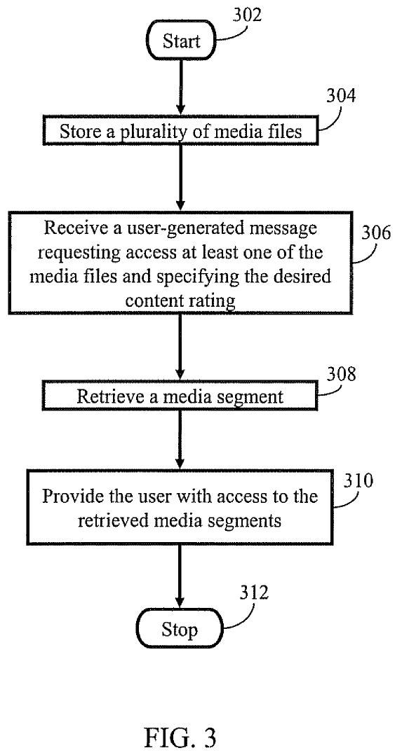

FIG. 3 illustrates a flow diagram of a method for selectively providing media content from the database 206 of media files, in accordance with an embodiment of the present invention. The method shows the different steps involved in selectively providing media content. To describe the flow diagram, reference will be made to FIG. 1 and FIG. 2, although it will be understood by a person ordinarily skilled in the art that the flow diagram can be implemented with reference to any other suitable embodiment of the present invention.

The method is initiated at step 302. At step 304, the MRA 102 stores a plurality of media files in the database 206. Each of the stored media files is identified by an overall primary content rating. The primary content rating of a media file is decided based on the suitability of the media file for users of different age group. Each media file includes one or more media segment. The media files can include redundant media segments. The redundant media segments may be encoded in different ways having dissimilar secondary content ratings. The secondary content rating of the media segment is decided based on the suitability of the media segment for users of different age group. At step 306, the user interface 202 receives a user-generated message, requesting access to a particular stored media file. The desired content rating for the requested media file is also specified. At step 308, the interface 204 retrieves the media segments of the requested particular media file from the database 206. The retrieved media segment does not exceed the specified desired content rating (described in detail in conjunction with FIG. 2). At step 310, the interface 204 provides the user with access to the retrieved media segments. Thereafter, the process terminates at step 312.

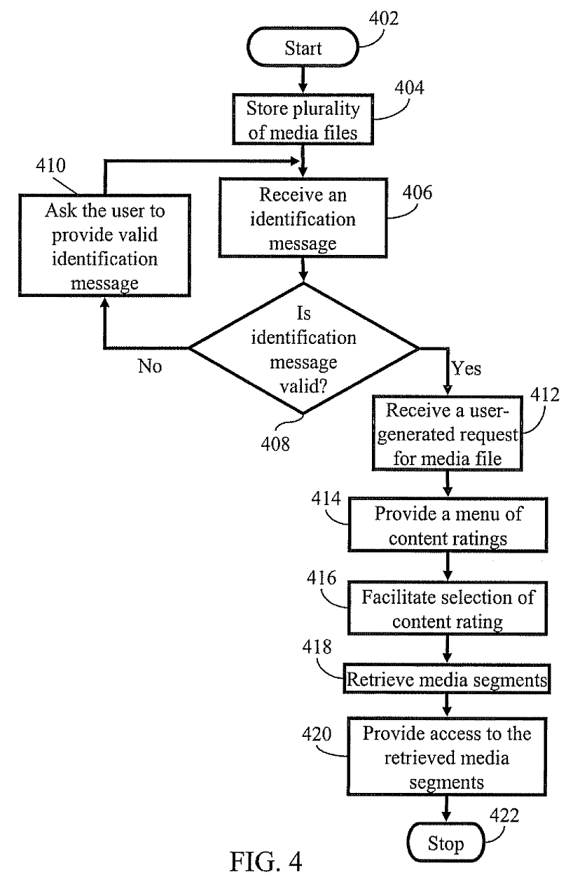

FIG. 4 illustrates a flow diagram of a method for selectively providing media content from the database 206 of media files, in accordance with another embodiment of the present invention. To describe the flow diagram, reference will be made to FIG. 1, FIG. 2 and, FIG. 3 although it will be understood by a person ordinarily skilled in the art that the flow diagram can be implemented with reference to any other suitable embodiment of the present invention. The method is initiated at step 402. At step 404, the MRA 102 stores a plurality of media files within the database 206. Each of the stored media files are identified by an overall primary content rating. A plurality of media segments are included in each of the media files. Each of the media segments are identified by a secondary content rating.

At step 406, the user interface 202 receives an identification message from the user. The identification message includes, but is not limited to, a password, a finger print recognition, a retinal scan and a RF key fob. [Query for the inventors: Please let us know if there are any other types of identification messages that you would like us to include in addition to those above listed.] The user is granted access to the requested media file after he identification message matches with previously stored user criteria. The predefined criteria may be an identification message provided by the user to the MRA 102 initially for his identification every time the user accesses the MRA 102, or the stored profiles. The predefined criteria are stored in the database 206 for reference. The primary and secondary content rating provided to the user for selection are based on the identification of the user. At step 408, the MRA 102 compares the received identification message with the previously stored user criteria. At step 410, when the identification message is not authenticated, the user interface 202 asks the user to provide a valid identification message and the method continues at step 406.

At step 412, when the identification message is authenticated at the step 408, the user interface 202 receives a user-generated request to access a particular media file in the database 206. At step 414, the interface 204 provides a menu of content ratings corresponding to the requested media file to the user. The user selects the primary and/or secondary rating from the menu of content rating. At step 416, the interface 204 facilitates selection of the primary and secondary content rating from the menu of content ratings by the user. At step 418, the interface 204 retrieves the media segments of the requested particular media file corresponding to the specified desired primary and/or secondary content ratings. The media segments retrieved by the interface 204 do not exceed the specified desired content ratings (described in detail in conjunction with FIG. 2). At step 420, the MRA 102 provides access of the retrieved media segments to the user. Thereafter, the process terminates at step 422.

For an embodiment, the MRA 102 modifies one or more secondary content ratings for the media segments of the requested media files in response to a user-generated request. Following the user-generated request to modify one or more secondary content ratings, the user interface 202 receives an identification message from the user. The MRA 102 compares the received identification message with previously stored user criteria. If the MRA 102 determines that the received identification message does not match with previously stored user criteria, the user interface 202 asks the user to provide a valid identification message. If, however, the MRA 102 determines that the received identification message matches with previously stored user criteria, the MRA 102 permits the user to modify one or more secondary content ratings. For example, if the parents feel that a media segment of G-rating is not suitable for their 17 year old child to watch, then they can change the G-rating of the media segment to R rating. Thereafter the media segment is restricted for the child.

For an embodiment, the database 206 may be present on a network server. In this embodiment, the database 206 can be accessed through a network by all the users connected to the network. Examples of the networks include, but are not limited to, Personal Area Network (PAN), Local Area Network (LAN), Metropolitan Area Network (MAN) and Wide Area Network (WAN). For another embodiment, the database 206 may comprise a customer premises storage system. Examples of the customer premises storage system include, but are not limited to, a Compact Disk (CD) player, a Digital Versatile Disk (DVD) player, a mobile phone, an MPEG-1 Audio Layer 3 (mp3) player, a computer and a music system. For yet another embodiment, the database 206 may comprise a computer-readable media. Examples of the computer-readable media include, but are not limited to, a hard disk, a CD-ROM, an optical storage device and a magnetic storage device.

Various embodiments, as described above, provide a method and system for selectively providing media content from the database of media files and thereby monitoring the media content. The parents can restrict access for their children to objectionable media segments in a media file. For example, in a TV-Y rated media content, there might be a media segment which some parents may found objectionable for viewing by their children. The parents can restrict access for their children to such an objectionable media segment without restricting the whole media file. [Query for the inventors: Please let us know if there are any other advantages that you would like us to include in addition to those listed above.]

It will be appreciated that the method and system for selectively providing media content from a database of media files, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method to enable users to select media contents from a database of media files differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for selectively providing media content from a database of media files, the method comprising:
storing a plurality of media files within the database, wherein each of the stored media files is identified by an overall primary content rating, and wherein a plurality of media segments within each of the media files are each identified by secondary content ratings;
receiving a user-generated message requesting access to at least one particular one of the stored media files, and specifying the desired content rating for the requested media file;
retrieving the media segments of the requested particular media file that do not exceed the specified desired content rating; and
providing the user with access to the retrieved media segments.

2. The method as recited in claim 1, wherein the media files comprise at least one of the following: a movie, a song, a video, a television program, an advertisement, a video game, a sporting event.

3. The method as recited in claim 1, wherein the content rating is selected from a group comprising a TV-Y (all children), a TV-Y7 (directed to children 7 and older), a TV-G (general audience), a TV-PG (parental guidance suggested), a TV-14 (parents strongly cautioned), and a TV-MA (mature audience only).

4. The method as recited in claim 1, wherein the content rating is selected from a group comprising a general audiences (G) rating, a parental guidance suggested (PG) rating, a parents strongly cautioned (PG-13) rating, a restricted (R) rating and a NC-17 rating.

5. The method as recited in claim 1 further comprising the steps of:
providing a menu of content ratings to the user; and
facilitating selection of a content rating from the menu by the user as a means of specifying the desired content rating for the requested media file.

6. The method as recited in claim 1, wherein the at least one of the plurality of media files stored within the database includes redundant segments, each of which is identified by dissimilar secondary content ratings.

7. The method as recited in claim 1, wherein the database comprises a network server.

8. The method as recited in claim 1, wherein the database comprises a customer premises storage system.

9. The method as recited in claim 1, wherein the database comprises computer-readable media.

10. The method as recited in claim 1, further comprising the steps:
receiving a message identifying the user;
comparing the received identification message with previously stored user criteria; and
granting the identified user access to the requested media file as a function of the comparison.

11. The method as recited in claim 1, further comprising the step of modifying one or more secondary content ratings for the media segments in response to a command received from a user.

12. The method as recited in claim 11, further comprising the steps:
receiving a message identifying the user;
comparing the received identification message with previously stored user criteria; and
permitting the identified user to modify one or more secondary content ratings as a function of the comparison.
[Note for Bob: Please note that we have included varying scope claims 18, 19 and 20 in order to cover the embodiment when the transceiver is not present. For example, if a user interface and an interface are present in the DVD players; user-generated request will not be required to be transmitted. Hence a transceiver is not required.]

13. A media retrieval appliance comprising:
a user interface adapted for receiving a user-generated request for access to at least a particular one of a plurality of stored media files, and specifying the desired content rating for the requested media file;
an interface providing a connection with a database storing a plurality of media files, wherein each of the stored media files is identified by an overall primary content rating, and wherein a plurality of media segments within each of the media files are each identified by secondary content ratings; and
a transceiver adapted to transmit the user-generated request to the database via the interface, and receive, in response to the transmitted request, the segments of the requested particular media file that do not exceed the specified desired content rating.

14. The media retrieval appliance as recited in claim 13, wherein the media files comprise at least one of the following: a movie, a song, a video, a television program, an advertisement, a video game, a sporting event.

15. The media retrieval appliance as recited in claim 13, wherein the content rating is selected from a group comprising a TV-Y (all children), a TV-Y7 (directed to children 7 and older), a TV-G (general audience), a TV-PG (parental guidance suggested), a TV-14 (parents strongly cautioned), and a TV-MA (mature audience only).

16. The media retrieval appliance as recited in claim 13, wherein the content rating is selected from a group comprising a general audiences (G) rating, a parental guidance suggested (PG) rating, a parents strongly cautioned (PG-13) rating, a restricted (R) rating and a NC-17 rating.

17. The media retrieval appliance as recited in claim 13 wherein the user interface is further adapted to provide the user with a menu of content ratings and facilitate the selection of a content rating from the menu by the user to specify the desired content rating for the requested media file.

18. A media retrieval appliance comprising:
a user interface adapted for receiving a user-generated request for access to at least a particular one of a plurality of stored media files, and specifying the desired content rating for the requested media file; and
an interface providing a connection with a database storing a plurality of media files, wherein each of the stored media files is identified by an overall primary content rating, and wherein a plurality of media segments within each of the media files are each identified by secondary content ratings.

19. The media retrieval appliance as recited in claim 18 further comprising a transceiver adapted to transmit the user-generated request to the database via the interface, and receive, in response to the transmitted request, the segments of the requested particular media file that do not exceed the specified desired content rating.

20. The media retrieval appliance as recited in claim 18 wherein the user interface is further adapted to provide the user with a menu of content ratings and facilitate the selection of a content rating from the menu by the user to specify the desired content rating for the requested media file
